(19) United States
(12) Patent Application Publication
(10) Pub. No.: US 2026/0221595 A1
(43) Pub. Date: Jul. 30, 2026

(54) SEPARATOR, SECONDARY BATTERY CONTAINING SAME, AND ELECTRONIC DEVICE

(71) Applicant: Ningde Amperex Technology Limited, Ningde, Fujian (CN)

(72) Inventor: Jian WU, Ningde (CN)

(73) Assignee: Ningde Amperex Technology Limited, Ningde, Fujian (CN)

(21) Appl. No.: 19/629,129

(22) Filed: Mar. 26, 2026

Related U.S. Application Data
(63) Continuation of application No. PCT/CN2023/122686, filed on Sep. 28, 2023.

(51) Int. Cl. H01M 50/42; H01M 10/0525; H01M 10/0587; H01M 50/403; H01M 50/426; H01M 50/434; H01M 50/443; H01M 50/449

(52) U.S. Cl. CPC H01M 50/42; H01M 10/0525; H01M 10/0587; H01M 50/403; H01M 50/426; H01M 50/434; H01M 50/443; H01M 50/449

(57) ABSTRACT

A separator includes a substrate layer, a first adhesive layer, and a second adhesive layer stacked sequentially. Both the first adhesive layer and the second adhesive layer are disposed on at least one side of the substrate layer. Both the first adhesive layer and the second adhesive layer extend from a first end of the separator toward a second end of the separator opposite to the first end of the separator. The first adhesive layer includes first adhesive particles. The second adhesive layer includes second adhesive particles. A particle diameter of each first adhesive particle is D₁ μm, and a particle diameter of each second adhesive particle is D₂ μm, D₂>D₁.

### CROSS REFERENCE TO RELATED APPLICATION

This application is a continuation application of International Application No. PCT/CN2023/122686, filed on Sep. 28, 2023, the contents of which are incorporated herein by reference in its entirety.

### TECHNICAL FIELD

This application relates to the technical field of energy storage, and in particular, to a separator, a secondary battery containing same, and an electronic device.

### BACKGROUND

Rechargeable electrochemical devices (such as a lithium-ion battery or a sodium-ion battery) are considered to be one of the most attractive energy storage systems by virtue of a high energy density, a relatively simple reaction mechanism, a high operating voltage, a long lifespan, environment-friendliness, and other advantages. Nowadays, electrochemical devices have been widely used in various fields such as wearable devices, smartphones, unmanned aerial vehicles, and laptop computers.

With the wide application of electrochemical devices in various fields, requirements on the electrochemical devices are increasingly higher. For example, an electrochemical device is expected to exhibit excellent cycle performance and safety in addition to a higher energy density. However, the electrochemical devices in the prior art can hardly meet the above requirements. Therefore, it is urgent to improve the cycle performance and safety performance of electrochemical devices while increasing the energy density of the electrochemical devices.

### SUMMARY

To solve at least the above problem, this application improves the cycle performance and safety performance of the electrochemical device by improving the separator of the electrochemical device.

According to one aspect of this application, this application provides a separator. The separator includes a substrate layer, a first adhesive layer, and a second adhesive layer stacked sequentially. Both the first adhesive layer and the second adhesive layer are disposed on at least one side of the substrate layer. Both the first adhesive layer and the second adhesive layer extend from a first end of the separator toward a second end of the separator opposite to the first end of the separator. The first adhesive layer includes first adhesive particles. The second adhesive layer includes second adhesive particles. A particle diameter of each first adhesive particle is D₁ μm, and a particle diameter of each second adhesive particle is D₂ μm, D₂>D₁.

According to an embodiment of this application, 0.1≤D₂−D₁≤10.

According to an embodiment of this application, 0.1≤D₂−D₁≤5.

According to an embodiment of this application, 0.01≤D₁≤1, and/or 0.1≤D₂≤10.

According to an embodiment of this application, a length L₂ of the second adhesive layer falls between a length L₃ of the substrate layer and ½L₃.

According to an embodiment of this application, the first adhesive layer extends from the first end of the separator to the second end of the separator.

According to an embodiment of this application, the first adhesive particles include one or more selected from the group consisting of ethyl polyacrylate, butyl polyacrylate, and poly(butadiene-co-isobutyl acrylate).

According to an embodiment of this application, the second adhesive particles include one or more selected from the group consisting of polyvinylidene fluoride, ethyl polyacrylate, and butyl polyacrylate.

According to an embodiment of this application, one of the first adhesive layer or the second adhesive layer includes a colorant.

According to an embodiment of this application, the colorant includes a chromophore group and an auxochrome group. The chromophore group includes at least one of an azo group (—N═N—) or a vinyl group (—C═C—). The auxochrome group includes one or more selected from the group consisting of —COOH, —NH₂, and —N(NH₃)₂.

According to an embodiment of this application, a thickness of the first adhesive layer is T₁ μm, and a thickness of the second adhesive layer is T₂ μm, T₁>T₂.

According to an embodiment of this application, 0.1≤T₁-T₂≤10.

According to an embodiment of this application, 0.1≤T₁-T₂≤5.

According to an embodiment of this application, the first adhesive layer is disposed on at least one surface of the substrate layer.

According to an embodiment of this application, the separator further includes a ceramic layer. The ceramic layer is located between the substrate layer and the first adhesive layer.

According to an embodiment of this application, a length L₁ of the first adhesive layer is greater than a length L₂ of the second adhesive layer such that at least a part, close to the second end of the separator, of the first adhesive layer is exposed from the second adhesive layer.

According to an embodiment of this application, in the first adhesive layer, at least a part of the first adhesive particles are spaced apart.

According to an embodiment of this application, in the second adhesive layer, at least a part of the second adhesive particles are spaced apart.

According to an embodiment of this application, the second adhesive particles are located on the first adhesive particles.

According to another aspect of this application, this application further provides a secondary battery. The secondary battery includes: a positive electrode plate, where the positive electrode plate includes a positive current collector and a positive active material layer disposed on the positive current collector, and the positive active material layer extends from a first end of the positive electrode plate toward a second end of the positive electrode plate opposite to the first end of the positive electrode plate; a negative electrode plate, where the negative electrode plate includes a negative current collector and a negative active material layer disposed on the negative current collector, and the negative active material layer extends from a first end of the negative electrode plate toward a second end of the negative electrode plate opposite to the first end of the negative electrode plate; and the separator disclosed in the above embodiment. The separator includes a substrate layer as well as a first adhesive layer and a second adhesive layer that are disposed on at least one surface of the substrate layer. Both the first adhesive layer and the second adhesive layer extend from a first end of the separator toward a second end of the separator opposite to the first end of the separator. The separator is located between the positive electrode plate and the negative electrode plate. The positive electrode plate, the separator, and the negative electrode plate are stacked and wound around a central axis to form a flat electrode assembly.

According to an embodiment of this application, a length dimension of the electrode assembly along the central axis is L cm, and a width dimension of the electrode assembly in a direction perpendicular to the central axis is W cm, L>W.

According to an embodiment of this application, the secondary battery satisfies (L_{c}+Lₐ)/2−[(N−1)/2]W+4≤L₂≤(L_{c}+Lₐ)/2−2W+4, where N is a number of winding layers of the electrode assembly and is a positive integer greater than or equal to 5, L_{c} is a length of the positive active material layer, and Lₐ is a length of the negative active material layer.

According to an embodiment of this application, the secondary battery further satisfies (L_{c}+Lₐ)/2−[(N−4)/2]W+4≤L₂≤(L_{c}+Lₐ)/2−4.2W+4.

According to an embodiment of this application, the separator includes the ceramic layer. The ceramic layer is located between the substrate layer and the first adhesive layer. A side of the separator, which contains the ceramic layer, is disposed toward the positive electrode plate.

According to another aspect of this application, this application further provides an electronic device. The electronic device includes the secondary battery disclosed in the above embodiment of this application.

According to another aspect of this application, this application further provides a method for preparing a secondary battery. The method includes: preparing a positive electrode plate; preparing a negative electrode plate; and preparing the separator disclosed in the above embodiment. The preparation of the separator includes: formulating a first slurry containing the first adhesive particles and a second slurry containing the second adhesive particles separately, applying the first slurry onto the substrate layer from the first end of the separator toward the second end of the separator opposite to the first end of the separator to form the first adhesive layer, and applying the second slurry onto the first adhesive layer from the first end of the separator toward the second end of the separator to form the second adhesive layer, where the particle diameter of each first adhesive particle is smaller than the particle diameter of each second adhesive particle.

According to an embodiment of this application, a length L₁ of the first adhesive layer is greater than a length L₂ of the second adhesive layer such that at least a part, close to the second end of the separator, of the first adhesive layer is exposed from the second adhesive layer.

According to an embodiment of this application, in the first adhesive layer, at least a part of the first adhesive particles are spaced apart.

According to an embodiment of this application, in the second adhesive layer, at least a part of the second adhesive particles are spaced apart.

According to an embodiment of this application, the second adhesive particles are located on the first adhesive particles.

### BRIEF DESCRIPTION OF DRAWINGS

For ease of describing an embodiment of this application, the following outlines the drawings needed for describing an embodiment of this application or the prior art. Evidently, the drawings outlined below are merely a part of embodiments in this application. A person skilled in the art can still derive the drawings of other embodiments according to the structures illustrated in the drawings.

FIG. 1 shows a scanning electron microscope (SEM) image of a jelly-roll structure of a lithium-ion battery that employs a separator provided in Comparative Embodiment 2 of this application after completion of 1000 charge-and-discharge cycles, and a close-up view of a tail region of the jelly-roll structure;

FIG. 2 shows an SEM image of a jelly-roll structure of a lithium-ion battery that employs a separator provided in Comparative Embodiment 1 of this application after completion of 1000 charge-and-discharge cycles, and a close-up view of a middle region of the jelly-roll structure;

FIG. 3 is a schematic structural diagram of a separator according to an embodiment of this application;

FIG. 4A and FIG. 4B are a plan-view SEM image and a cross-sectional SEM image, respectively, of a separator in a crease region of a jelly-roll structure according to an embodiment of this application;

FIG. 5 is a schematic structural diagram of a separator according to another embodiment of this application; and

FIG. 6 is a schematic structural diagram of a positive electrode, a separator, and a negative electrode stacked in sequence according to this application.

### DETAILED DESCRIPTION

Some embodiments of this application will be described in detail below. No embodiment of this application is to be construed as a limitation on this application.

The terms “include”, “comprise” and “contain” used herein are open and mean including but without limitation.

In addition, a quantity, a ratio, or another numerical value herein is sometimes expressed in the format of a range. Understandably, such a range format is set out for convenience and brevity, and needs to be flexibly understood to include not only the numerical values explicitly specified and defined by the range, but also all individual numerical values or sub-ranges covered in the range as if each individual numerical value and each sub-range were explicitly specified.

In the description of specific embodiments and claims, a list of items referred to by using the terms such as “one or more of”, “one or more thereof”, “at least one of” or other similar terms may mean any combination of the listed items. For example, if items A and B are listed, the phrases “at least one of A and B” and “at least one of A or B” mean: A alone; B alone; or both A and B. In another example, if items A, B, and C are listed, the phrase “at least one of A, B, or C” means: A alone; B alone; C alone; A and B (excluding C); A and C (excluding B); B and C (excluding A); or all of A, B, and C. The item A may include a single element or a plurality of elements. The item B may include a single element or a plurality of elements. The item C may include a single element or a plurality of elements.

An electrochemical device (such as a lithium-ion battery) typically includes a positive electrode plate (also referred to as a cathode), a negative electrode plate (also referred to as an anode), and a separator. The separator is located between the positive electrode plate and the negative electrode plate to prevent short circuits. A conventional lithium-ion battery mainly comes in two structures: a jelly-roll structure and a stacked structure. In a jelly-roll structure, the positive electrode plate, the negative electrode plate, and the separator are all elongated strips, and the separator is placed between the positive electrode plate and the negative electrode plate. During assembling, the positive electrode plate, the negative electrode plate, and the separator are wound around winding pin to form an electrode assembly, and then subjected to sealing, electrolyte injection, and chemical formation to complete the production process. In contrast, a stacked structure differs in that a plurality of positive tabs and a plurality of negative tabs need to be welded together separately.

However, it is found in this application that an electrochemical device of a jelly-roll structure exhibits significant capacity fading during charge-and-discharge cycles (for example, after 1000 charge-and-discharge cycles), thereby resulting in deterioration of cycle performance and safety performance. Further research in this application reveals that during charge-and-discharge cycles of a jelly-roll battery, a purple-spotted lithium plating interface is formed in a local region on the electrode plate (especially in the crease region of a jelly-roll battery), thereby causing local interface anomalies.

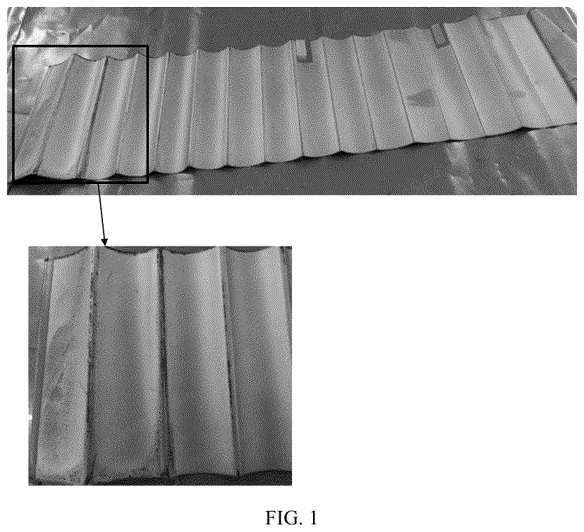

On the one hand, during the winding of an electrode plate, the radius of curvature of the jelly-roll structure gradually increases when the winding proceeds from an inner turn to an outer turn. At the tail end of the jelly-roll structure (for example, at the last 2 to 3 folds of the jelly-roll structure), the winding is relatively loose. Consequently, the gap between the positive/negative electrode plate and the separator in the fold region is relatively large, and needs to be filled with more electrolyte solution, and is prone to loss of electrolyte solution after hundreds or thousands of charge-and-discharge cycles of the battery. Furthermore, a relatively large gap also increases the lithium-ion transport path, and causes a relatively great mass transfer resistance. Under the combined effects of electrolyte solution loss and an increased lithium-ion mass transfer resistance, lithium ions are prone to deposit at the fold regions at the tail of the jelly-roll structure, thereby forming a purple-spotted lithium plating interface and causing local interface anomalies. For example, as shown in FIG. 1, after 1000 charge-and-discharge cycles, the lithium-ion battery in Comparative Embodiment 2 of this application exhibits an obvious purple-spotted lithium plating interface at the fold region at the last 2 to 3 folds of the jelly-roll structure.

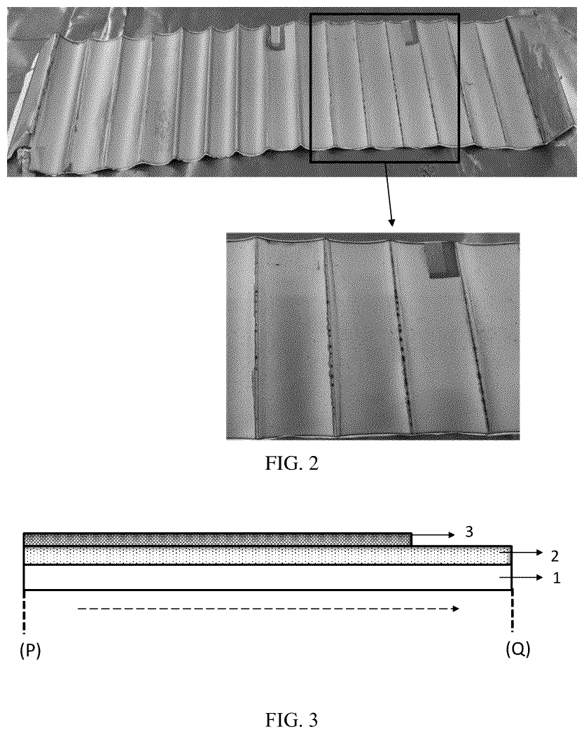

On the other hand, unlike the tail region of the jelly-roll structure, the crease gap in the middle region of the jelly-roll structure is relatively small. During electrochemical charge-and-discharge cycles, the continuous intercalation and deintercalation of lithium ions between the positive electrode and the negative electrode causes considerable expansion and shrinkage of the volume of the electrode plate, and squeezes out electrolyte solution, thereby resulting in loss of electrolyte solution, thereby forming a purple-spotted lithium plating interface in the crease region in the middle of the jelly-roll structure. For example, as shown in FIG. 2, after 1000 charge-and-discharge cycles, the lithium-ion battery in Comparative Embodiment 1 of this application exhibits an obvious purple-spotted lithium plating interface at the fold region near the middle position of the jelly-roll structure.

To address the above technical challenges and based on the above findings, this application proposes increasing the crease gap in the middle region of the jelly-roll structure and decreasing the crease gap in the tail region of the jelly-roll structure, so as to supply sufficient electrolyte solution and promote lithium-ion transport during the charging and discharging of the electrochemical device, and consequently reduce lithium plating. Accordingly, this application discloses a double-coated separator to solve the above technical problem.

In an embodiment, as shown in FIG. 3, a separator disclosed herein includes a substrate layer 1, a first adhesive layer 2, and a second adhesive layer 3. Both the first adhesive layer 1 and the second adhesive layer 2 are disposed on one side of the substrate layer 1. As indicated by the dashed arrow in FIG. 3, both the first adhesive layer 1 and the second adhesive layer 2 extend from a first end (P) of the separator toward a second end (Q) of the separator opposite to the first end (P) of the separator. At least a part, close to the second end of the separator, of the first adhesive layer 1 is exposed from the second adhesive layer 3. The first adhesive layer 1 includes first adhesive particles, and the second adhesive layer 2 includes second adhesive particles. A particle diameter of each first adhesive particle is D₁ μm, and a particle diameter of each second adhesive particle is D₂ μm, D₂>D₁. FIG. 3 merely shows the first adhesive layer and the second adhesive layer disposed on one side of the substrate layer. However, understandably, the first adhesive layer and the second adhesive layer may be disposed on the other side, or on both sides, of the substrate layer.

The substrate layer includes a starting end and an ending end opposite to the starting end in a length direction of the substrate layer (for example, in the direction indicated by the dashed arrow in FIG. 3). In some embodiments, the second adhesive layer and the first adhesive layer extend from the starting end of the substrate layer toward the ending end opposite to the starting end along the length direction of the substrate layer. In some embodiments, at least a part of the second adhesive particles in the second adhesive layer are spaced apart. That is, there are gaps between the second adhesive particles, thereby facilitating electrolyte solution infiltration and increasing ion channels. The gaps may be formed by spraying and applying a slurry using a spraying device. In some embodiments, all the second adhesive particles are spaced apart, also forming the second adhesive layer that falls within the protection scope of this application. The extending, by the second adhesive layer, from the starting end of the substrate layer toward the ending end means that the second adhesive particles are provided at intervals in the direction from the starting end of the substrate layer toward the ending end. In some embodiments, at least a part of the first adhesive particles in the first adhesive layer are spaced apart. That is, there are gaps between the first adhesive particles, thereby facilitating electrolyte solution infiltration and increasing ion channels. The gaps may be formed by spraying and applying a slurry using a spraying device. In some embodiments, the extending of the second adhesive layer and/or the first adhesive layer are continuous and uninterrupted, thereby enhancing the adhesion between the adhesive layer and the substrate layer and/or the electrode plate. In some embodiments, the first adhesive layer extends from the starting end of the substrate layer to the ending end of the substrate layer.

In some embodiments, the electrochemical device (for example, a secondary battery) includes a positive electrode plate, a negative electrode plate, and the separator disclosed in the above embodiment. The separator is located between the positive electrode plate and the negative electrode plate. The positive electrode plate includes a positive current collector and a positive active material layer disposed on the positive current collector. The positive active material layer extends from a first end of the positive electrode plate toward a second end of the positive electrode plate opposite to the first end of the positive electrode plate. The negative electrode plate includes a negative current collector and a negative active material layer disposed on the negative current collector. The negative active material layer extends from a first end of the negative electrode plate toward a second end of the negative electrode plate opposite to the first end of the negative electrode plate. During preparation of the electrochemical device, the positive electrode plate, the separator, and the negative electrode plate are stacked to form a stacked structure. Starting from the first end of the separator, the stacked structure is wound around a central axis into a flat jelly-roll structure (also referred to as an electrode assembly) along the length direction of the stacked structure (for example, the direction shown in FIG. 3).

In the manner described above, in most of the starting crease regions (at least the crease regions at the head and middle part) of the jelly-roll structure, a first adhesive layer containing small-diameter adhesive particles and a second adhesive layer containing large-diameter adhesive particles are simultaneously provided on the substrate layer of the separator. The second adhesive layer is located on the surface of the first adhesive layer to enlarge the crease gap of the electrode plate in the middle region of the jelly-roll structure, so as to allow more electrolyte solution to be contained in the crease gap, and consequently reduce deposition of the metallic lithium. Furthermore, because the tail region of the jelly-roll structure is coated with only an adhesive layer containing small-diameter adhesive particles, the resulting gap in the crease region is relatively small, thereby reducing the lithium-ion mass transfer resistance and reducing deposition of the metallic lithium.

In some embodiments, the head region, middle region, and tail region described above each account for one-third of the total length of the substrate layer. In some embodiments, the tail region accounts for at most ⅓, ¼, ⅕, ⅙, 1/7, ⅛, 1/9, or 1/10 of the total length of the substrate layer. In some embodiments, the head region and middle region may be collectively referred to as a front region, and the front region accounts for at least ⅔, ¾, ⅘, ⅚, 6/7, ⅞, 8/9, or 9/10 of the total length of the substrate layer.

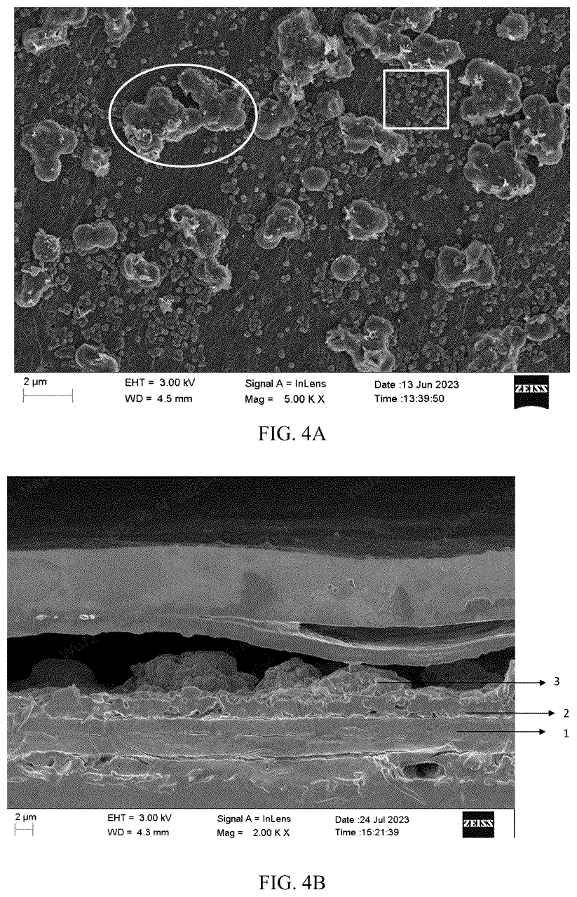

FIG. 4A and FIG. 4B herein show a plan-view SEM image and a cross-sectional SEM image, respectively, of a separator in a crease region of a jelly-roll structure according to an embodiment of this application. As shown in FIG. 4A, numerous small-diameter adhesive particles (for example, small-diameter adhesive particles indicated by the box in FIG. 4A) are distributed on the substrate, and large-diameter adhesive particles (for example, large-diameter adhesive particles indicated by the elliptical box in FIG. 4A) are distributed on the small-diameter adhesive particles. FIG. 4B shows a cross-sectional SEM image of the separator disclosed in this application. As shown in FIG. 4B, the separator includes a substrate layer 1, a first adhesive layer 2 containing small-diameter adhesive particles, and a second adhesive layer 3 containing large-diameter adhesive particles. The first adhesive layer 2 is disposed between the substrate layer 1 and the second adhesive layer 3.

In some embodiments, the particle diameter D₁ m of the first adhesive particles satisfies 0.01≤D₁≤1. In some embodiments, D₁ may be, but is not limited to, 0.01, 0.1, 0.2, 0.3, 0.4, 0.5, 0.6, 0.7, 0.8, 0.9, 1, or a value falling within a range formed by any two thereof.

In some embodiments, the particle diameter D₂ μm of the second adhesive particles satisfies 0.1≤D₂≤10. In some embodiments, D₂ may be, but is not limited to, 0.1, 1, 2, 3, 4, 5, 6, 7, 8, 9, 10, or a value falling within a range formed by any two thereof.

It is worth noting that the particle diameters of the first adhesive particle and the second adhesive particle are calculated through statistical simulation using scanning electron microscopy (SEM). For example, a specific testing method for the particle diameters may be learned with reference to the detailed embodiment section below.

In some embodiments, the particle diameter difference between the first adhesive particle and the second adhesive particle satisfies 0.1≤D₂−D₁≤10. In some embodiments, the particle diameter difference may be, but is not limited to, 0.1, 1, 2, 3, 4, 5, 6, 7, 8, 9, 10, or a value falling within a range formed by any two thereof. In some embodiments, 0.1≤D₂−D₁≤5.

In an embodiment, the length of the first adhesive layer and the length of the second adhesive layer are L₁ mm and L₂ mm, respectively, L₁>L₂. In this way, at least a part of the first adhesive layer, which is close to the second end (for example, the ending end) of the separator, is exposed from the second adhesive layer. The exposed part of the first adhesive layer is formed at the tail of the jelly-roll structure or in the winding outer layer.

In some embodiments, the length of the substrate layer is L₃ mm, and the second adhesive layer accounts for at least a half of the total length of the substrate layer, that is, ½L₃≤L₂<L₃. In some embodiments, L₂ may be, but is not limited to ½L₃, ⅔L₃, ¾L₃, ⅘L₃, ⅚L₃, 6/7L₃, ⅞L₃, 8/9L₃, 9/10L₃, or a value falling within a range formed by any two thereof. For example, ¾L₃≤L₂≤ 9/10L₃.

In some embodiments, the lengths of the first adhesive layer and the substrate layer satisfy L₁≤L₃. In some embodiments, the first adhesive layer accounts for at least 60%, at least 70%, at least 75%, at least 80%, at least 85%, at least 90%, at least 95%, or at least 98% of the total length of the substrate layer. In some embodiments, the first adhesive layer accounts for the total length of the substrate layer.

In some embodiments, the first adhesive particles, include but are not limited to, one or more selected from the group consisting of ethyl polyacrylate, butyl polyacrylate (PAB), and poly(butadiene-co-isobutyl acrylate). In some embodiments, the second adhesive particles include, but are not limited to, one or more selected from the group consisting of polyvinylidene fluoride (PVDF), ethyl polyacrylate, and butyl polyacrylate (PAB). The particle diameters of the ethyl polyacrylate and the butyl polyacrylate (PAB) may vary depending on the degree of polymerization, so that the first adhesive layer and the second adhesive layer can be selected depending on the particle diameter.

In some embodiments, one of the first adhesive layer or the second adhesive layer includes a colorant. For example, the first adhesive layer includes a colorant while the second adhesive layer includes no colorant. In other embodiments, the second adhesive layer includes a colorant while the first adhesive layer includes no colorant. The colorant serves to determine the position and length of the second adhesive layer to ensure that at least a part of the first adhesive layer is exposed from the second adhesive layer.

In some embodiments, the colorant may be a commonly used colorant in the art. For example, the colorant includes a chromophore group and an auxochrome group. The chromophore group includes, but is not limited to, at least one of an azo group (—N═N—) or a vinyl group (—C═C—). The auxochrome group includes, but is not limited to, one or more selected from the group consisting of an acidic group such as COOH or an alkaline group such as —NH₂ and N(NH₃)₂. In some embodiments, the colorant may be, but is not limited to, at least one of fuchsin, congo red, methyl blue, methyl green, or gentian violet.

In some embodiments, the thickness of the first adhesive layer is T₁ μm, and the thickness of the second adhesive layer is T₂ μm, T₁>T₂.

In some embodiments, 0.5≤T₁≤15. In some embodiments, T₁ may be, but is not limited to, 0.5, 1, 2, 3, 4, 5, 6, 7, 8, 9, 10, 11, 12, 13, 14, 15, or a value falling within a range formed by any two thereof.

In some embodiments, 0.01≤T₂≤5. In some embodiments, T₂ may be, but is not limited to, 0.01, 0.1, 1, 2, 3, 4, 5, or a value falling within a range formed by any two thereof.

In some embodiments, a difference between the thickness of the first adhesive layer and the thickness of the second adhesive layer satisfies 0.1≤T₁−T₂≤10. In some embodiments, the difference may be, but is not limited to, 0.1, 1, 2, 3, 4, 5, 6, 7, 8, 9, 10, or a value falling within a range formed by any two thereof. In some embodiments, 0.1≤T₁−T₂≤5.

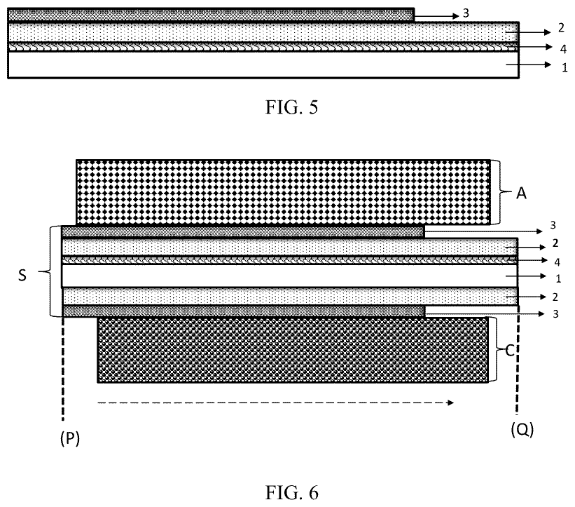

In some embodiments, as shown in FIG. 5, the separator further includes a ceramic layer 4. The ceramic layer 4 is located between the substrate layer 1 and the first adhesive layer 2. The ceramic layer mainly serves to protect the separator, improve the oxidation resistance and strength of the separator, and reduce the risk of local micro-short-circuits in the separator. The components of the ceramic layer may be, but are not limited to, at least one of aluminum oxide, boehmite, zirconium oxide, boron nitride, silicon nitride, or aluminum nitride.

In some embodiments, the substrate layer in this application may include, but is not limited to, at least one of: polyethylene (PE), ultra-high molecular weight polyethylene (UHMWPE), high-density polyethylene (HDPE), polypropylene (PP), polyethylene terephthalate (PET), polyphenylene sulfide (PPS), cellulose, polyimide, polystyrene (PS), poly-4-methyl-1-pentene (TPX), polymethyl methacrylate (PMMA), polyvinylidene fluoride (PVDF), polyvinylidene fluoride-hexafluoropropylene (PVDF-HFP), polytetrafluoroethylene (PTFE), or polysulfone.

In some embodiments, the thickness of the substrate layer in this application is H₁ m, 3≤H₁≤10. In some embodiments, H₁ may be, but is not limited to, 3, 4, 5, 6, 7, 8, 9, 10, or a value falling within a range formed by any two thereof.

### Electrochemical Device

In addition, this application provides an electrochemical device. The electrochemical device includes the separator disclosed in the above embodiment of this application. In some embodiments, the electrochemical device further includes a negative electrode, a positive electrode, and an electrolyte solution, where the separator is located between the positive electrode and the negative electrode.

The electrochemical device according to this application may be any device in which an electrochemical reaction occurs. Specific examples of the electrochemical device include all kinds of primary batteries, secondary batteries, fuel batteries, solar batteries, or capacitors. In particular, the electrochemical device is a lithium secondary battery, including a lithium metal secondary battery, a lithium-ion secondary battery, a lithium polymer secondary battery, or a lithium-ion polymer secondary battery.

In some embodiments, as shown in FIG. 6, during preparation of the electrochemical device, the positive electrode C, the separator S, and the negative electrode A are stacked sequentially to form a stacked structure. Starting from the first end (P) of the separator, the stacked structure is wound around a central axis into a flat jelly-roll structure (also referred to as an electrode assembly) along the length direction of the stacked structure (that is, the direction oriented toward the second end (Q) of the separator). It is worth noting that in actual production of an electrode assembly, the length of the separator is typically greater than the length of the positive electrode and the length of the negative electrode to achieve complete isolation between the positive electrode and the negative electrode. Compared to the positive active material carried by the positive electrode C, the negative electrode A is typically required to contain an excess negative active material to avoid lithium plating. Moreover, understandably, FIG. 6 shows only a schematic diagram of a stacked structure formed by the separator S, the negative electrode A, and the positive electrode C. However, those skilled in the art can appropriately adjust the arrangement and length of the positive electrode, the negative electrode, and the separator according to actual conditions to achieve the concept enlightened by this application. The length of the jelly-roll structure is along the central axis of the jelly-roll structure, is denoted as L cm. The width of the jelly-roll structure is along a direction perpendicular to the central axis of the jelly-roll structure (and different from the thickness direction), is denoted as W cm, L>W. In this way, in at least the head and middle regions of the jelly-roll structure, the separator includes both a second adhesive layer and a first adhesive layer, thereby increasing the gap between the crease regions, and consequently reducing deposition of metallic lithium. However, in the tail region of the jelly-roll structure, the separator includes only the first adhesive layer, thereby reducing the gap between the crease regions at the tail, and consequently reducing deposition of metallic lithium.

In addition, FIG. 6 shows a scenario in which the second adhesive layer and the first adhesive layer are disposed on both sides of the substrate layer of the separator. However, understandably, the second adhesive layer and the first adhesive layer may be disposed on only one side of the substrate layer instead.

Further, it is found in this application that by designing and matching the dimensions of the positive electrode, the negative electrode, and the first adhesive layer in the electrochemical device, this application can further improve the cycle stability of the electrochemical device. Specifically, it is found in this application that when the electrochemical device further satisfies the following formula, the cycle performance and safety performance can be more excellent:

$$( {L}_{c} + {L}_{a} ) / 2 - [ ( N - 1 ) / 2 ] W + 4 \leq {L}_{2} \leq ( {L}_{c} + {L}_{a} ) / 2 - 2 W + 4 .$$

In the formula above, L_{c} is the length of the positive active material applied on the positive electrode, Lₐ is the length of the negative active material applied on the negative electrode, W is the width of the jelly-roll structure, L₁ is the length of the first adhesive layer, and N is the number of winding layers of the jelly-roll structure and is a positive integer greater than or equal to 5.

In some embodiments, the performance of the electrochemical device can be further improved when the following formula is further satisfied:

$$( {L}_{c} + {L}_{a} ) / 2 - [ ( N - 4 ) / 2 ] W + 4 \leq {L}_{2} \leq ( {L}_{c} + {L}_{a} ) / 2 - 4.2 W + 4 .$$

In some embodiments such as the embodiment shown in FIG. 6, when a ceramic layer is applied on only one side of the separator substrate, the side of the separator, which contains the ceramic layer, is disposed toward the positive electrode plate. That is because, as found in this application, one side of the separator, which faces the positive electrode plate, is more prone to breakage, and the ceramic layer applied on the one side of the separator, which faces the positive electrode plate, can play a significant protective role.

Next, this application will describe in detail the composition of a positive electrode, a negative electrode, and an electrolyte.

### Positive Electrode

The positive electrode includes a positive electrode material. The positive electrode material includes a positive electrode material capable of absorbing and releasing lithium (Li) (hereinafter sometimes referred to as “positive electrode material capable of absorbing/releasing lithium Li”). Examples of the positive electrode material capable of absorbing or releasing lithium (Li) may include lithium cobalt oxide, lithium nickel cobalt manganese oxide, lithium nickel cobalt aluminum oxide, lithium manganese oxide, lithium iron manganese phosphate, lithium vanadium phosphate, lithium vanadyl phosphate, lithium iron phosphate, lithium titanium oxide, and a lithium-rich manganese-based materials.

Specifically, the chemical formula of the lithium cobalt oxide may be chemical formula 1:

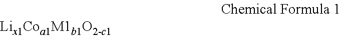

In the formula above, M1 is at least one selected from nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), yttrium (Y), lanthanum (La), zirconium (Zr), and silicon (Si); and values of x1, a1, b1, and c1 fall within the following ranges: 0.8≤x1≤1.2, 0.8≤a1≤1, 0≤b1≤0.2, −0.1≤c1≤0.2, respectively.

The chemical formula of lithium nickel cobalt manganese oxide or lithium nickel cobalt aluminum oxide may be chemical formula 2:

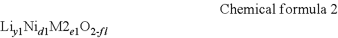

In the formula above, M2 is at least one selected from cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), zirconium (Zr), and silicon (Si); and the values of y1, d1, e1, and f1 fall within the following ranges: 0.8≤y1≤1.2, 0.3≤d1≤0.98, 0.02≤e1≤0.7, −0.1≤f1≤0.2, respectively.

The chemical formula of the lithium manganese oxide may be chemical formula 3:

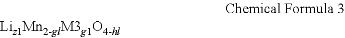

In the formula above, M3 is at least one selected from cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); and the values of z1, g1, and h1 fall within the following ranges: 0.8≤z1≤1.2, 0≤g1<1.0, and −0.2≤h1≤0.2, respectively.

### Negative Electrode

The negative electrode includes a negative electrode material. The negative electrode material includes a negative electrode material capable of absorbing and releasing lithium (Li) (hereinafter sometimes referred to as “negative electrode material capable of absorbing/releasing lithium Li”). Examples of the negative electrode material capable of absorbing/releasing lithium (Li) may include a carbon material, a metal compound, an oxide, a sulfide, a lithium nitride such as LiN₃, a lithium metal, a metal that combines with lithium into an alloy, and a polymer material.

Examples of the carbon material may include low-graphitization carbon, easily graphitizable carbon, artificial graphite, natural graphite, mesocarbon microbead, soft carbon, hard carbon, pyrolytic carbon, coke, glassy carbon, an organic polymer compound sintered body, carbon fibers, and activated carbon. The coke may include pitch coke, needle coke, and petroleum coke. The organic polymer compound sintered body means a material obtained by calcining a polymer material such as phenol plastic or furan resin at an appropriate temperature until carbonization. Some of the obtained material is classed into low-graphitization carbon and easily graphitizable carbon. Examples of the polymer material may include polyacetylene and polypyrrole.

Among the negative electrode materials capable of absorbing/releasing lithium (Li), further, a material with charge and discharge voltages close to the charge and discharge voltages of lithium metal is selected. That is because, the lower the charge and discharge voltages of the negative electrode material, the more easily the electrochemical device (such as a lithium-ion battery) can achieve a higher energy density. A carbon material may be selected as the negative electrode material. Because a crystal structure of the carbon material changes just a little during charging and discharging, the carbon material helps to achieve excellent cycle performance and a high charge capacity and discharge capacity. Especially, graphite may be selected as the negative electrode material because graphite provides a large electrochemical equivalent and a high energy density.

In addition, the negative electrode materials capable of absorbing/releasing lithium (Li) may include simple-substance lithium metal, a metal element or semi-metal element alloyable with lithium (Li), an alloy or compound containing such element, and the like. Especially, the negative electrode materials are used together with a carbon material to achieve excellent cycle characteristics and a high energy density. The alloy used herein may be an alloy that contains two or more metal elements, or may be an alloy that contains one or more metal elements and one or more semi-metal elements. The alloy may be in one of the following states: solid solution, eutectic crystal (eutectic mixture), intermetallic compound, and a mixture thereof.

Examples of the metal elements and semi-metal elements may include tin (Sn), lead (Pb), aluminum (Al), indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). Examples of the alloy and compound may include a material represented by a chemical formula MaₛMbₜLiᵤ and a material represented by a chemical formula MaₚMc_{q}Mdᵣ. In such chemical formulas, Ma represents at least one element among the metal elements and semi-metal elements that can combine with lithium to form an alloy; Mb represents at least one element among the metal elements and semi-metal elements other than lithium and Ma; Mc represents at least one element among non-metal elements; Md represents at least one element among the metal elements and semi-metal elements other than Ma; and s, t, u, p, q, and r satisfy s>0, t≥0, u≥0, p>0, q>0, and r≥0.

In addition, an inorganic compound containing no lithium (Li), such as MnO₂, V₂O₅, V₆O₁₃, NiS, and MoS, may be used in the negative electrode.

### Electrolyte

The electrolyte may be one or more of a gel electrolyte, a solid-state electrolyte, or an electrolyte solution. The electrolyte solution includes a lithium salt and a nonaqueous solvent.

The lithium salt is one or more selected from LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoroborate. For example, the lithium salt is LiPF₆ because it provides a high ionic conductivity and improves cycle characteristics.

The nonaqueous solvent may be a carbonate ester compound, a carboxylate ester compound, an ether compound, another organic solvent, or any combination thereof.

The carbonate ester compound may be a chain carbonate ester compound, a cyclic carbonate ester compound, a fluorocarbonate ester compound, or any combination thereof.

Examples of the chain carbonate compound are diethyl carbonate (DEC), dimethyl carbonate (DMC), dipropyl carbonate (DPC), methyl propyl carbonate (MPC), ethylene propyl carbonate (EPC), ethyl methyl carbonate (EMC), or any combination thereof. Examples of the cyclic carbonate compound are ethylene carbonate (EC), propylene carbonate (PC), butylene carbonate (BC), vinyl ethylene carbonate (VEC), or any combination thereof. Examples of the fluorocarbonate compound are fluoroethylene carbonate (FEC), 1, 2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, trifluoromethyl ethylene carbonate, or any combination thereof.

Examples of the carboxylate compound are methyl acetate, ethyl acetate, n-propyl acetate, tert-butyl acetate, methyl propionate, ethyl propionate, propyl propionate, γ-butyrolactone, decanolactone, valerolactone, mevalonolactone, caprolactone, methyl formate, and any combination thereof.

Examples of the ether compound are dibutyl ether, tetraglyme, diglyme, 1,2-dimethoxyethane, 1,2-diethoxyethane, ethoxy-methoxyethane, 2-methyltetrahydrofuran, tetrahydrofuran, or any combination thereof.

Examples of the other organic solvent are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, and any combination thereof.

This application further provides a method for preparing a secondary battery. The method includes: stacking a positive electrode, a separator, and a negative electrode sequentially to form a stacked structure, where the positive electrode, the separator, and the negative electrode share a common starting end; winding the stacked structure from the starting end to form a jelly-roll structure; placing the jelly-roll structure into a packaging shell, injecting an electrolyte solution, and sealing the packaging shell to obtain the secondary battery.

This application further provides an electronic device. The electronic device includes the electrochemical device (such as a secondary battery) disclosed herein.

The uses of the electrochemical device of this application are not particularly limited, and the electrochemical device may be used in any electronic device known in the prior art. In some embodiments, the electrochemical device of this application is applicable to, but not limited to use in, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, lithium-ion capacitor, and the like.

By using a lithium-ion battery as an example, the following describes a preparation method of a lithium-ion battery with reference to specific embodiments. A person skilled in the art understands that the preparation methods described in this application are merely examples, and any other appropriate preparation methods still fall within the scope of this application.

### Embodiments

The following describes some embodiments and comparative embodiments of preparing a lithium-ion battery according to this application, and evaluates performance of the lithium-ion batteries.

### I. Preparation of a Lithium-Ion Battery

### 1. Method for Preparing a Separator

First, applying a boehmite ceramic layer onto a PE substrate, and then applying a first adhesive layer on both sides of the substrate successively, where the coating weight of the first adhesive layer is 1.1 mg/5000 mm². Subsequently, applying a second adhesive layer onto both sides of the substrate, where the coating weight of the second adhesive layer is 5 mg/5000 mm², and the second adhesive layer is doped with a colorant in an amount equal to 0.5% of the amount of large-diameter adhesive particles added; and then cutting the separator into specified widths. Both the first adhesive layer and the second adhesive layer extend from the starting end of the separator toward the ending end opposite to the starting end. At least a part, close to the ending end, of the first adhesive layer is exposed from the second adhesive layer. The adhesive particles used in the first adhesive layer and the second adhesive layer and the coating lengths thereof will be described in specific embodiments.

### 2. Method for Preparing a Lithium-Ion Battery

Dissolving lithium cobalt oxide as a positive active material, conductive carbon (Super P), and polyvinylidene difluoride (PVDF) as a binder at a mass ratio of 96:2:2 in an N-methylpyrrolidone solvent system, and mixing well to form a positive electrode slurry. Using aluminum foil as a positive current collector, applying the positive electrode slurry onto the aluminum foil from the starting end of the aluminum foil toward the ending end opposite to the starting end, and performing oven-drying, cold-pressing, and slitting to obtain a positive electrode.

Dissolving artificial graphite as a negative active material, Super P as a conductive agent, styrene-butadiene rubber as a binder, and sodium carboxymethyl cellulose as a thickener at a mass ratio of 98:0.5:1:0.5 in a deionized water solvent system, and mixing well to obtain a negative electrode slurry. Using copper foil as a negative current collector, applying the negative electrode slurry onto the copper foil from the starting end of the copper foil toward the ending end opposite to the starting end, and performing oven-drying, cold-pressing, and slitting to obtain a negative electrode. The coating length of the positive and the coating length of the negative electrode will be described in specific embodiments.

Mixing a lithium salt LiPF₆ and a nonaqueous organic solvent at a mass ratio of 8:92 to obtain a solution serving as an electrolyte solution of the lithium-ion battery, where the nonaqueous organic solvent is a product of mixing ethylene carbonate (EC), diethyl carbonate (DEC), propylene carbonate (PC), propyl propionate (PP), and vinylene carbonate (VC) at a mass ratio of 20:30:20:28:2.

Stacking the positive electrode plate, the separator, and the negative electrode plate to form a stacked structure, and winding the stacked structure around a central axis into a flat electrode assembly by starting from the first end of the separator. Placing the electrode assembly into an outer package, injecting the electrolyte solution into the package, sealing the package, and performing chemical formation to finally obtain a lithium-ion battery. The width W of the jelly-roll electrode assembly is 43 mm, and the number of winding layers N is 17.

### II. Test Methods

### 1. Test of the Particle Diameter of the Adhesive Particles

### Test Instrument: Scanning Electron Microscope (SEM)

Test method and procedure: The particle diameter of small-diameter adhesive particles may be determined in the following procedure: Observing the plane of the crease region of the jelly-roll structure using SEM. Selecting 10 small-diameter adhesive particles within a field of view of 5 μm×5 μm or 10 μm×10 μm, measuring the maximum size of each particle, using the measured maximum size as the particle diameter, and then averaging out the measured values, and denoting the average value as D₁. The particle diameter of large-diameter adhesive particles may be determined in the following procedure: Observing the plane of the crease region of the jelly-roll structure using SEM. Selecting 10 large-diameter adhesive particles within a field of view of 15 μm×15 μm, measuring the maximum size of each particle, using the measured maximum size as the particle diameter, and then averaging out the measured values, and denoting the average value as D₂.

### 2. Electrochemical Test

Charge-and-discharge cycle test on a battery: Charging a battery at a constant current of 1.5 C until the voltage reaches 4.5 V, and then charging the battery at a constant voltage until the current tapers off to 0.05 C, and then leaving the battery to stand for 3 minutes; discharging the battery at a constant current of 0.7 C until the voltage drops to 3.0 V, thereby completing one cycle. Repeating the above procedure for 1000 charge-and-discharge cycles.

Measuring the initial thickness of the battery before charge-and-discharge cycling using a parallel-plate thickness gauge, and recording the measured value as T₀ mm; and then measuring the thickness of the battery in a fully charged state after 500 and 1000 charge-and-discharge cycles separately, and recording the thicknesses as T₅₀₀ mm and T₁₀₀₀ mm respectively.

### III. Test Results

Table 1 shows how the separator prepared using the double adhesive layer coating process disclosed in this application affects the electrochemical properties of a lithium-ion battery. The length of the second adhesive layer is 632 mm, the length of the first adhesive layer is 325 mm, the length of the positive active material applied on the positive electrode is 622 mm, and the length of the negative active material applied on the negative electrode is 628 mm. The initial thickness of the lithium-ion battery in Table 1 is 3.8 mm.

TABLE 1

| | Second | First | | | | T₅₀₀ | T₁₀₀₀ |
|---|---|---|---|---|---|---|---|
| | adhesive | adhesive | D₂ (μm) | D₁ (μm) | D₂ − D₁ (μm) | (mm) | (mm) |
| Comparative | / | PAB | / | 0.1 | / | 4.10 | 4.26 |
| Embodiment 1-1 | | | | | | | |
| Comparative | PVDF | / | 1 | | / | 4.11 | 4.29 |
| Embodiment 1-2 | | | | | | | |
| Comparative | PVDF | PAB | 0.3 | 0.7 | −0.4 | 4.10 | 4.25 |
| Embodiment 1-3 | | | | | | | |
| Embodiment 1-1 | PVDF | PAB | 6 | 1 | 5 | 4.04 | 4.13 |
| Embodiment 1-2 | PVDF | PAB | 0.11 | 0.1 | 0.01 | 4.09 | 4.19 |
| Embodiment 1-3 | PVDF | PAB | 1 | 0.1 | 0.9 | 4.02 | 4.10 |
| Embodiment 1-4 | PVDF | PAB | 10.01 | 0.01 | 10 | 4.06 | 4.15 |
| Embodiment 1-5 | PVDF | PAB | 0.11 | 0.01 | 0.1 | 4.04 | 4.13 |
| Embodiment 1-6 | PVDF | PAB | 10 | 1 | 9 | 4.06 | 4.14 |
| Embodiment 1-7 | PVDF | PAB | 1.1 | 1 | 0.1 | 4.03 | 4.12 |
| Embodiment 1-8 | PVDF | PAB | 11 | 0.1 | 10.9 | 4.08 | 4.18 |
| Embodiment 1-9 | PVDF | PVAC | 1 | 0.1 | 0.9 | 4.03 | 4.11 |
| Embodiment 1-10 | PAB | PVAC | 1 | 0.1 | 0.9 | 4.03 | 4.12 |

As shown in Table 1, in contrast to Comparative Embodiment 1-3, the thickness of the battery in the embodiments is significantly reduced after the separator is coated with both the first adhesive layer and the second adhesive layer after 500 and 1000 charge-and-discharge cycles. This indicates that the separator disclosed herein can effectively suppress deposition of metallic lithium in the crease gaps of the jelly-roll structure, thereby improving cycle stability and safety performance of the electrochemical device. Further, Table 1 also shows that when adjusted to satisfy 0.1≤D₂−D₁≤10, the particle diameter of the adhesive particles can further improve the performance of the electrochemical device. The improvement effect for the electrochemical device is even more significant when the particle diameter of the adhesive particles further satisfies 0.1≤D₂−D₁≤5.

Table 2 shows how the thicknesses of the first adhesive layer and the second adhesive layer affect the electrochemical properties of a lithium-ion battery. The embodiments in Table 2 are a result of adjustment based on Embodiment 1-3 in Table 1, and differ only in the thicknesses of the first adhesive layer and the second adhesive layer.

TABLE 2

| | T₁ | T₂ | T₁ − T₂ | T₅₀₀ | T₁₀₀₀ |
|---|---|---|---|---|---|
| | (μm) | (μm) | (μm) | (mm) | (mm) |
| Embodiment 2-1 | 0.6 | 0.1 | 0.05 | 4.08 | 4.17 |
| Embodiment 2-2 | 0.2 | 0.1 | 0.1 | 4.03 | 4.12 |
| Embodiment 2-3 | 1.1 | 0.1 | 1 | 4.02 | 4.11 |
| Embodiment 2-4 | 5.01 | 0.1 | 5 | 4.02 | 4.10 |
| Embodiment 2-5 | 8.01 | 0.1 | 8 | 4.05 | 4.15 |
| Embodiment 2-6 | 10.1 | 0.1 | 10 | 4.05 | 4.15 |
| Embodiment 2-7 | 11.1 | 0.1 | 11 | 4.07 | 4.18 |

As can be seen from Table 2, controlling the thicknesses of the first adhesive layer and the second adhesive layer to satisfy 0.1≤T₁−T₂≤10 can further improve the performance of the electrochemical device. The improvement effect for the electrochemical device is even more significant when the particle diameter of the adhesive particles further satisfies 0.1≤T₁−T₂≤5.

Table 3 shows how the length of the first adhesive layer in the separator affects the electrochemical properties of a lithium-ion battery when the lengths of the positive electrode and the negative electrode in the battery are constant. The embodiments in Table 3 are a result of adjustment based on Embodiment 1-3 in Table 1, and differ only in the parameters listed in Table 3.

TABLE 3

| | | | | (L_{c} + Lₐ)/2 − | (L_{c} + Lₐ)/2 − | (L_{c} + Lₐ)/ | (L_{c} + Lₐ)/ | | |
|---|---|---|---|---|---|---|---|---|---|
| | L_{c} | Lₐ | L₂ | [(N − 1)/ | [(N − 4)/ | 2 − 2 | 2 − 4.2 | T₅₀₀ | T₁₀₀₀ |
| | (mm) | (mm) | (mm) | 2]W + 4 | 2]W + 4 | W + 4 | W + 4 | (mm) | (mm) |
| Embodiment 3-1 | 622 | 628 | 270 | 285 | 349.5 | 543 | 452.7 | 4.08 | 4.17 |
| Embodiment 3-2 | 622 | 628 | 285 | 285 | 349.5 | 543 | 452.7 | 4.06 | 4.14 |
| Embodiment 3-3 | 622 | 628 | 350 | 285 | 349.5 | 543 | 452.7 | 4.02 | 4.08 |
| Embodiment 3-4 | 622 | 628 | 450 | 285 | 349.5 | 543 | 452.7 | 4.03 | 4.09 |
| Embodiment 3-5 | 622 | 628 | 543 | 285 | 349.5 | 543 | 452.7 | 4.05 | 4.11 |
| Embodiment 3-6 | 622 | 628 | 565 | 285 | 349.5 | 543 | 452.7 | 4.07 | 4.16 |

As can be seen from Table 3, controlling the length of the second adhesive layer in the separator to satisfy (L_{c}+Lₐ)/2−[(N−1)/2]W+4≤L₂≤(L_{c}+Lₐ)/2−2W+4 can further improve the performance of the electrochemical device. Furthermore, controlling the length of the second adhesive layer to satisfy (L_{c}+Lₐ)/2−[(N−4)/2]W+4≤L₂≤(L_{c}+Lₐ)/2−4.2W+4 can further optimize the performance of the electrochemical device.

References to “embodiments”, “some embodiments”, “an embodiment”, “another example”, “example”, “specific example” or “some examples” throughout the specification mean that specified features, structures, materials, or characteristics described in such embodiment(s) or example(s) are included in at least one embodiment or example in this application. Therefore, descriptions throughout the specification, which make references by using expressions such as “in some embodiments”, “in an embodiment”, “in one embodiment”, “in another example”, “in an example”, “in a specific example”, or “example”, do not necessarily refer to the same embodiment(s) or example(s) in this application. In addition, specific features, structures, materials, or characteristics herein may be combined in one or more embodiments or examples in any appropriate manner.

Although illustrative embodiments have been demonstrated and described above, a person skilled in the art understands that the foregoing embodiments are never to be construed as a limitation on this application, and changes, replacements, and modifications may be made to the embodiments without departing from the spirit, principles, and scope of this application.

What is claimed is:

1. A separator, comprising a substrate layer, a first adhesive layer, and a second adhesive layer stacked sequentially; wherein both the first adhesive layer and the second adhesive layer are disposed on at least one side of the substrate layer; and both the first adhesive layer and the second adhesive layer extend from a first end of the separator toward a second end of the separator, the second end of the separator is opposite to the first end of the separator; and
the first adhesive layer comprises first adhesive particles, the second adhesive layer comprises second adhesive particles, a particle diameter of each first adhesive particle is D₁ μm, and a particle diameter of each second adhesive particle is D₂ μm, D₂>D₁.

2. The separator according to claim 1, wherein 0.1≤D₂−D₁≤10.

3. The separator according to claim 1, wherein 0.01≤D₁≤1, and/or 0.1≤D₂≤10.

4. The separator according to claim 1, wherein a length L₂ of the second adhesive layer falls between a length L₃ of the substrate layer and ½L₃.

5. The separator according to claim 1, wherein the first adhesive layer extends from the first end of the separator to the second end of the separator; or
the first adhesive layer is disposed on at least one surface of the substrate layer; or
the separator further comprises a ceramic layer, wherein the ceramic layer is located between the substrate layer and the first adhesive layer.

6. The separator according to claim 1, wherein the first adhesive particles comprise one or more selected from the group consisting of ethyl polyacrylate, butyl polyacrylate, and poly(butadiene-co-isobutyl acrylate); and/or
the second adhesive particles comprise one or more selected from the group consisting off polyvinylidene fluoride, ethyl polyacrylate, and butyl polyacrylate.

7. The separator according to claim 1, wherein one of the first adhesive layer or the second adhesive layer comprises a colorant.

8. The separator according to claim 7, wherein the colorant comprises a chromophore group and an auxochrome group; the chromophore group comprises at least one of an azo group (—N═N—) or a vinyl group (—C═C—); and the auxochrome group comprises one or more selected from the group consisting of —COH, —NH₂, and —N(NH₃)₂.

9. The separator according to claim 1, wherein a thickness of the first adhesive layer is T₁ m, a thickness of the second adhesive layer is T₂ μm, and T₁>T₂.

10. The separator according to claim 9, wherein 0.1≤T₁−T₂≤10.

11. The separator according to claim 1, wherein a length L₁ of the first adhesive layer is greater than a length L₂ of the second adhesive layer such that at least a part of the first adhesive layer towards the second end is exposed from the second adhesive layer.

12. The separator according to claim 1, wherein in the first adhesive layer, at least a part of the first adhesive particles are spaced apart; and/or
in the second adhesive layer, at least a part of the second adhesive particles are spaced apart.

13. The separator according to claim 12, wherein at least a part of the second adhesive particles are located on surfaces of the first adhesive particles.

14. A secondary battery, comprising:
a positive electrode plate, wherein the positive electrode plate comprises a positive current collector and a positive active material layer disposed on the positive current collector; and the positive active material layer extends from a first end of the positive electrode plate toward a second end of the positive electrode plate, the second end of the positive electrode plate is opposite to the first end of the positive electrode plate;
a negative electrode plate, wherein the negative electrode plate comprises a negative current collector and a negative active material layer disposed on the negative current collector; and the negative active material layer extends from a first end of the negative electrode plate toward a second end of the negative electrode plate, the second end of the negative electrode plate is opposite to the first end of the negative electrode plate; and
a separator, the separator comprises a substrate layer, a first adhesive layer, and a second adhesive layer stacked sequentially; wherein both the first adhesive layer and the second adhesive layer are disposed on at least one side of the substrate layer; and both the first adhesive layer and the second adhesive layer extend from a first end of the separator toward a second end of the separator, the second end of the separator is opposite to the first end of the separator;
the first adhesive layer comprises first adhesive particles, the second adhesive layer comprises second adhesive particles, a particle diameter of each first adhesive particle is D₁ μm, and a particle diameter of each second adhesive particle is D₂ μm, D₂>D₁; wherein
the separator is located between the positive electrode plate and the negative electrode plate; and the positive electrode plate, the separator, and the negative electrode plate are stacked and wound around a central axis to form a flat electrode assembly.

15. The secondary battery according to claim 14, wherein a length dimension of the electrode assembly along the central axis is L cm, and a width dimension of the electrode assembly in a direction perpendicular to the central axis is W cm, and L>W.

16. The secondary battery according to claim 15, wherein the secondary battery satisfies (L_{c}+Lₐ)/2−[(N−1)/2]W+4≤L₂≤(L_{c}+Lₐ)/2−2W+4, wherein N is a number of winding layers of the electrode assembly and is a positive integer greater than or equal to 5; L_{c} is a length of the positive active material layer; and Lₐ is a length of the negative active material layer.

17. The secondary battery according to claim 16, wherein (L_{c}+Lₐ)/2−[(N−4)/2]W+4≤L₂≤(L_{c}+Lₐ)/2−4.2W+4.

18. The secondary battery according to claim 14, wherein the separator comprises a ceramic layer, the ceramic layer is located between the substrate layer and the first adhesive layer, and a side of the separator which contains the ceramic layer is disposed toward the positive electrode plate.

19. An electronic device, comprising the secondary battery according to claim 14.

20. A method for preparing a secondary battery, comprising:
preparing a positive electrode plate;
preparing a negative electrode plate;
preparing the separator according to claim 1, wherein the preparation of the separator comprises: formulating a first slurry containing the first adhesive particles and a second slurry containing the second adhesive particles separately; applying the first slurry onto the substrate layer from the first end of the separator toward the second end of the separator to form the first adhesive layer; applying the second slurry onto the first adhesive layer from the first end of the separator toward the second end of the separator to form the second adhesive layer; wherein the particle diameter of each first adhesive particle is smaller than the particle diameter of each second adhesive particle.
